(19) United States
(12) Patent Application Publication
(10) Pub. No.: US 2001/0037709 A1
(43) Pub. Date: Nov. 8, 2001

(54) Overlay pinch mechanism

(76) Inventors: Richard Kuchta, Shickshinny, PA (US); Alexander Zusmanovich, South Windsor, CT (US); Joseph Vivirito, South Windsor, CT (US)

Correspondence Address: Marina F. Cunningham, McCormick, Paulding & Huber, CityPlace ll, 185 Asylum Street, Hartford, CT, 06103-3402, US

(21) Appl. No.: 09/909,455

(22) Filed: Jul. 19, 2001

Related U.S. Application Data
(62) Division of application No. 09/116,499, filed on Jul. 16, 1998.

(51) Int. Cl. B26D 7/06

(52) U.S. Cl. 83/23; 83/155

(57) ABSTRACT

A cutter system for cutting a single ply or multiple plies of limp material, or a lay, into a plurality of parts includes a cutter table for supporting the lay with a cutter head for cutting the lay into parts. The cutter system also includes a pair of overlay pinch mechanisms for preventing an overlay material, placed atop of the lay, from being displaced during transitioning of the lay from the cutter table onto a take-off table. Each overlay pinch mechanism includes a bracket for securing the overlay pinch mechanism onto the take-off table and a loaded clamp attaching onto the bracket. The clamp has an engaged position and a disengaged position. In the engaged position, a wheel, pivotably secured to the damp, engages the overlay material to prevent displacement thereof during transitioning of the lay from the cutter table onto the take-off table.

### BACKGROUND OF THE INVENTION

1. Technical Field

The present invention relates to cloth cutter systems and, more particularly, to a mechanism for preventing an overlay material, placed atop of a lay of cutting material, from being displaced during transitioning of the lay from a cutter table onto a take-off table.

2. Background Art

Conventional cutter systems for cutting a single ply or multiple plies of limp material, referred to as a lay, include a cutter table for supporting the lay and a cutter head, movable with respect to the cutter table. The cutter head includes a cutter tool for penetrating and cutting the lay into parts of predetermined size and shape. The cutter table includes a conveyor which advances the cut lay along the cutter table and moves the lay from the cutter table onto a conveyorized take-off table. The parts are subsequently removed from the take-off table and distributed to their appropriate destinations. A plurality of transitioning fingers connect the cutter table with the take-off table.

The conveyorized support surface of the cutter table is air permeable and includes a plurality of bristle blocks that minimize slippage and movement of the lay during the cutting operation. The air permeable bristle blocks allow vacuum air generated by a vacuum source, disposed underneath the cutter table surface, to pass therethrough. The vacuum draws the lay toward the cutting surface, compressing the plies and preventing the material plies from moving during the cutting operations. To achieve vacuum during the cutting operations, a layer of an overlay material is placed over the lay. Typically, a thin plastic sheet is used as the overlay material.

During the cutting operation, the overlay material is pulled tightly over the lay by the vacuum. Once the cutting operation is completed, the lay is moved onto the take-off table by the cutter table conveyor. However, during the transitioning of the lay from the cutter table onto the take-off table, the overlay material, that is no longer held in place by the vacuum, can be easily displaced. The displaced overlay material tends to bunch up and get caught in the bristles of the cutter table and in the transitioning fingers. The bunched overlay material drags cut parts from the lay that also become caught in the transitioning fingers. The caught fabric parts are damaged and have to be discarded. Additionally, the caught fabric parts may damage the transitioning fingers.

Frequently, to prevent loss of cut parts and potential damage to the cutters, one or two people stand along the sides of the cutter table to ensure that the overlay material does not get caught on the bristles or in the transitioning fingers.

It is an object of the present invention to ensure a smooth transition of the lay of cut material parts from the cutter table onto the take-off table.

It is another object of the present invention to eliminate the need for people to oversee transitioning of the lay from the cutter table onto the take-off table.

### SUMMARY OF THE INVENTION

The invention resides in a method and apparatus for preventing displacement of overlay material during transition of a lay from a cutter table onto a take-off table. According to the present invention, an overlay pinch apparatus includes a pair of overlay pinch mechanisms disposed on opposite sides of the take-off table. Each overlay pinch mechanism includes a bracket for attaching the mechanism onto the take-off table and a damp for pivotally attaching onto the bracket and for rotatably supporting a wheel to prevent the overlay material from being displaced. The clamp has an engaged position and a disengaged position. In the engaged position, the wheel applies pressure to the overlay material and holds it firmly against the conveyor surface of the take-off table.

The overlay pinch apparatus ensures that the overlay material is maintained under tension such that the lay with the overlay material can be conveyed from the cutter table onto the take-off table without getting caught in the bristles or transitioning fingers. The overlay pinch apparatus eliminates the need for people to oversee the transitioning of the lay from the cutter table onto the take-off table.

One advantage of the present invention is that cut parts do not get pulled by the overlay material into the transitioning fingers to become damaged.

Another advantage of the present invention is that the cutting equipment does not become damaged as a result of cut parts being caught in the transitioning fingers.

The foregoing and other advantages of the present invention become more apparent in light of the following detailed description of the exemplary embodiments thereof, as illustrated in the accompanying drawings.

### BRIEF DESCRIPTION OF THE DRAWINGS

FIG. 1 is a simplified perspective view of a cutter table with a cutter head and a take-off table connected thereto by means of transitioning fingers with overlay pinch mechanisms supporting an overlay material placed on top of a lay;

FIG. 2 is a simplified, enlarged, fragmentary perspective view of the overlay pinch mechanism of FIG. 1 in an engaged position engaging the overlay material, according to the present invention;

FIG. 3 is a simplified side elevation of the overlay pinch mechanism of FIG. 2 in the engaged position; and

FIG. 4 is a simplified side elevation of the overlay pinch mechanism of FIG. 3 in a disengaged position.

### DETAILED DESCRIPTION OF THE INVENTION

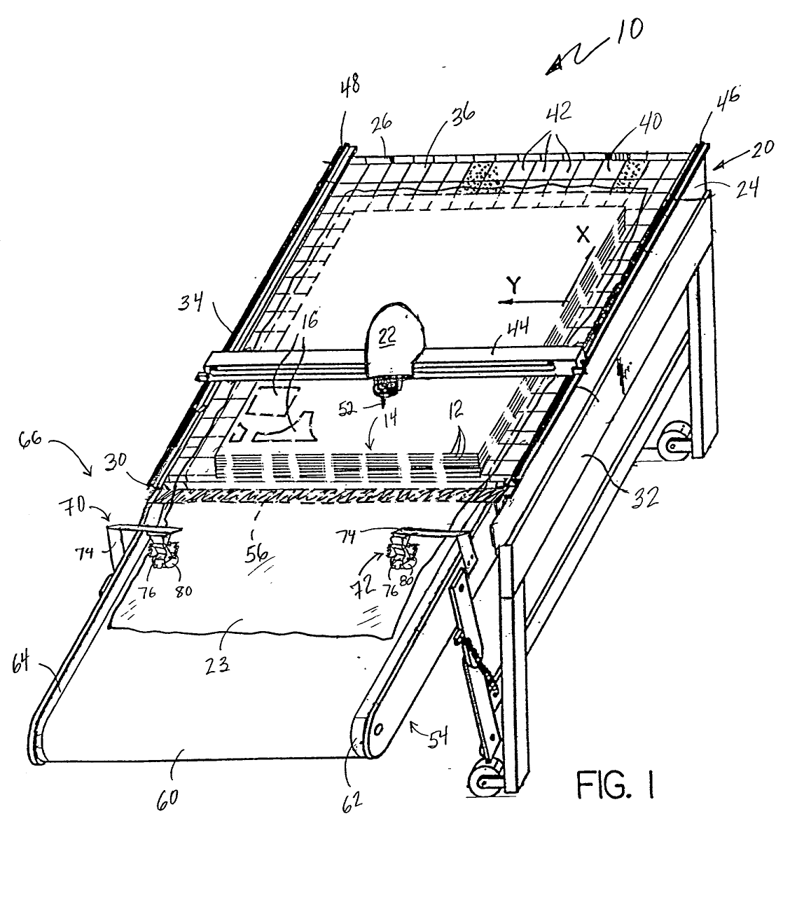

Referring to FIG. 1, a cutter system 10 for cutting a single ply or multiple plies 12 of limp material, defining a lay 14, into a plurality of parts 16 includes a cutter table 20 for supporting the lay 14 and a cutter head 22 movable with respect to the cutter table 20. A layer of an overlay material 23 is disposed over the lay 14. The cutter table 20 includes a frame 24 and extends from a take-on end 26 to a take-off end 30 in a longitudinal or X-coordinate direction and from a console side 32 to a remote side 34 in a lateral or Y-coordinate direction. The cutter table 20 also includes a conveyor 36 for advancing the lay 14 along the cutter table 20 in the longitudinal direction from the take-on end 26 to the take-off end 30. The cutter table conveyor 36 includes a support surface 40 comprising a plurality of air permeable bristle blocks 42. A vacuum source (not shown), disposed underneath the cutter table support surface 40, generates vacuum that passes through the air permeable cutter table support surface 40 to draw the lay 14 toward the cutter table support surface 40.

The cutter head 22 is supported by a cutter head beam 44 which is guided in the longitudinal direction along a pair of guide rails 46, 48, disposed on each side of the cutter table 20. The cutter head 22 supports a cutter tool 52 and is movable in the lateral direction along the cutter head beam 44.

A take-off table 54 is disposed adjacent to the cutter table 20 at the take-off end 30 thereof. A plurality of transitioning fingers 56 connect the cutter table 20 with the take-off table 54. The take-off table 54 includes a conveyor 60 flanged by support runners 62, 64 on each side thereof with the conveyor 60 having a textured surface.

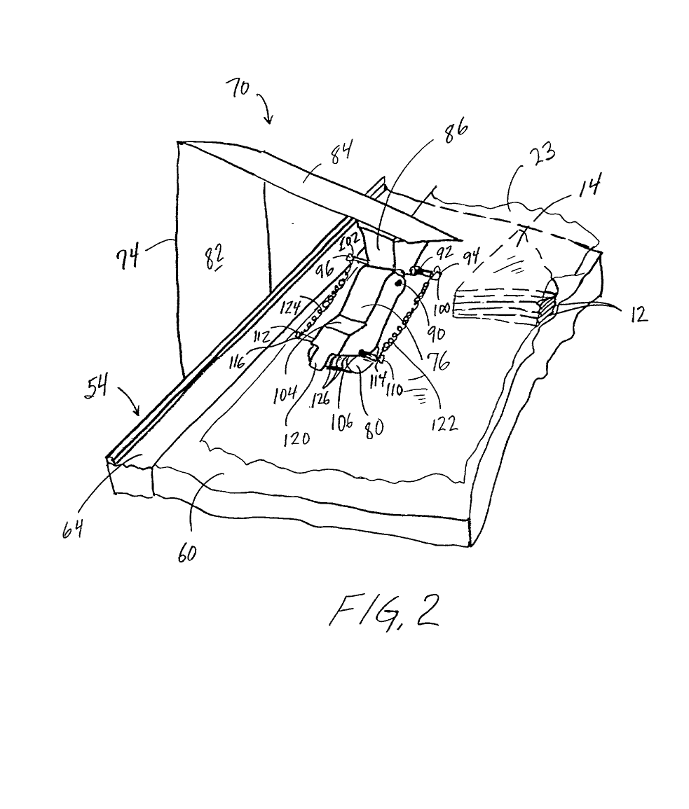

An overlay pinch apparatus 66 includes a first overlay pinch mechanism 70 and a second overlay pinch mechanism 72 with each of the overlay pinch mechanisms 70, 72 being disposed on each side of the take-off table 54. Referring to FIG. 2, each overlay pinch mechanism 70, 72 includes a bracket assembly 74 for attaching onto the take-off table 54 and a spring loaded toggle clamp 76 for supporting a rotatable wheel 80. The bracket assembly 74 is L-shaped and is formed by a first flange 82 and a second flange 84. The first flange 82 is secured onto a side of the take-off table 54. The second flange 84 supports an arm 86 having the toggle clamp pivotably attached thereto by means of a pivot 90. The arm 86 further includes a pin 92 passing therethrough in a substantially parallel relationship to the pivot 90. The pin 92 includes first and second pin ends 94, 96 protruding from the arm and having first and second grooves 100, 102 formed on each respective pin end 94,96.

The toggle clamp 76 has a clamp body 104 for supporting the wheel 80 that is rotatable about a wheel shaft 106. The wheel shaft 106 is disposed in a substantially parallel relationship to the pivot 90 and includes first and second shaft ends 110, 112 protruding outward from the clamp body 104. Each shaft end 110, 112 includes a shaft groove 114, 116, respectively. The toggle clamp body 104 also forms a handle 120 protruding slightly past the wheel 80. A pair of springs 122, 124 engage the toggle clamp 76 and the arm 86. Each spring 122, 124 fits into the shaft groove 114, 116 and into the pin groove 100, 102, respectively.

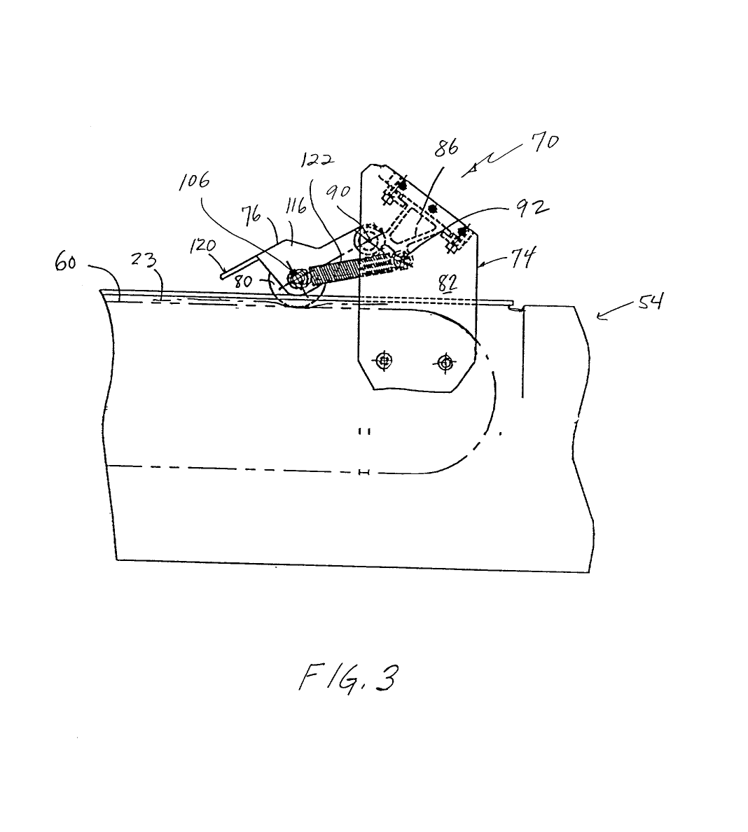

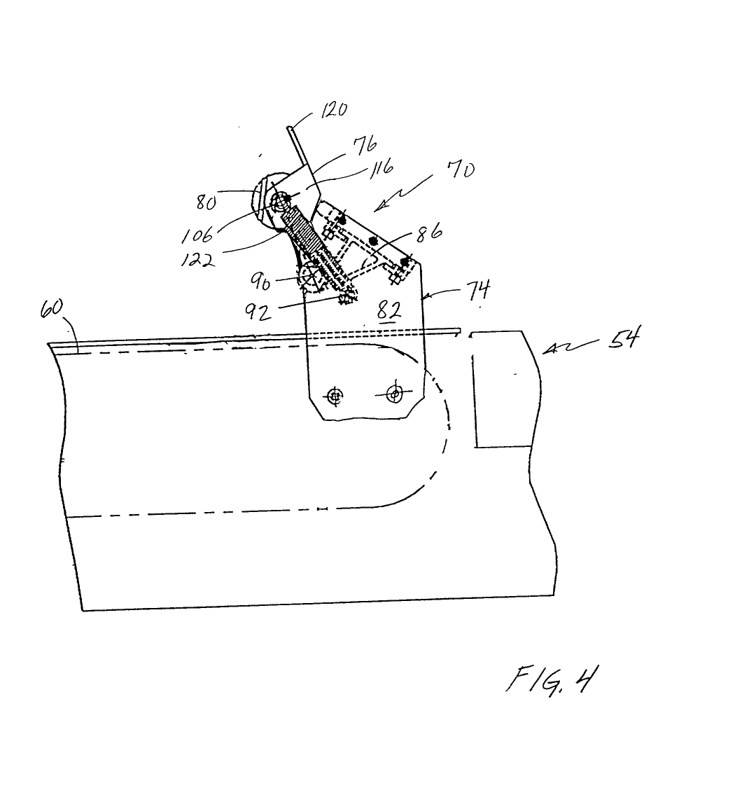

Referring to FIGS. 3 and 4, the toggle clamp 76 has an engaged position, shown in FIG. 3, and a disengaged position, shown in FIG. 4. In the disengaged position, the toggle clamp 76 is an upward position and does not interfere with the overlay material 23 or the take-off table 54. The toggle clamp 76 rests against the bracket 74 and is held in place by the spring tension. In the engaged position, the spring tension urges the clamp 76 towards the take-off table conveyor surface 60. In the engaged position, the clamp 76 is tensioned to prevent slip between the wheel 80 and the conveyor surface 60. The wheel 80 is fabricated from rubber and includes a plurality of ribs 126, as best shown in FIG. 2, to ensure that the overlay material 23 is held firmly against the conveyor 60 of the take-off table 54.

In operation, at the beginning of a cutting operation the overlay pinch mechanisms 70, 72 are in the disengaged position, as shown in FIG. 3. The lay 14 is placed on the take-on end 26 of the cutter table 20. The overlay material 23 is pulled on top of the lay 14 such that the overlay material 23 overhangs on both sides of the lay 14 since the overlay material 23 is wider than the lay 14 in the lateral direction. The overlay material 23 also overhangs the lay 14 in the longitudinal direction and extends past the transitioning fingers 56 onto the take-off table 54, as shown in FIG. 1. The vacuum draws both, the lay 14 and the overlay material 23, toward the cutter table support surface 40.

Once the overlay material is placed onto the take-off table 54, the overlay pinch mechanisms 70, 72 are rotated into the engaged position. The clamp portions 76 of the overlay pinch mechanisms 70, 72 are placed over the overlay material with the wheels 80 coming into contact with the overlay material 23. The spring loaded toggle clamp portions 76 exert pressure on the overlay material 23 to prevent it from being displaced.

During the cutting operation, the cutter head beam 44 moves in the longitudinal direction along the guide rails 46, 48 while the cutter head 22 with the cutter tool 52 moves in the lateral direction along the cutter head beam 44 in accordance with a cutting program resident in the cutter head 22. Thus, the lay 14 with the overlay material 23 is cut into the plurality of parts 16. Once the cutting operation is completed, the cut lay 14 is advanced to the take-off table 54. The cutter table conveyor 36 moves the lay 14 with the overlay material 23 towards the transitioning fingers 56 and the take-off table 54. As the cutter table conveyor 36 advances the lay 14 toward the take-off table 54, the overlay pinch mechanisms 70, 72, in cooperation with the take-off table conveyor 60, maintain the overlay material in tension and also advance the overlay material 23 along the take-off table. As the take-off table conveyor 60 moves in the longitudinal direction, the wheels 80 of the overlay pinch mechanisms 70, 72 rotate and hold the overlay material firmly against the take-off table conveyor 60, thereby moving the overlay material 23 forward along the take-off table 54.

As the lay 14 is transitioned over the transitioning fingers 56 and onto the take-off table 54, the overlay pinch mechanisms 70, 72 continue to maintain the overlay material 23 in tension and pressed against the take-off table conveyor 60. The wheels 80 of the overlay pinch mechanisms 70, 72 are disposed in close proximity to the support runners 62, 64 to ensure that the overlay pinch mechanisms 70, 72 do not interfere with the lay 14 passing therebetween. Thus, subsequent to the lay 14 being conveyed onto the take-off table 54 and as the lay 14 is advanced along the take-off table 54, the overlay pinch mechanisms 70, 72 continue to maintain the overlay material 23 in tension and pressed against the take-off table conveyor 60. For subsequent cutting operations, the overlay pinch mechanisms 70, 72 are already in the engaged position and continue to maintain the overlay material 23 in tension and advance it along the take-off table 14.

The overlay pinch apparatus 66 ensures that the overlay material 23 is maintained under tension such that the lay 14 with the overlay material 23 can be conveyed from the cutter table 20 onto the take-off table 54 without getting caught in the bristle blocks 42 of the bristle blocks 42 or transitioning fingers 56. The overlay pinch apparatus 66 eliminates the need for people to oversee the transitioning of the lay 14 from the cutter table 20 onto the take-off table 54.

One advantage of the present invention is that cut parts 16 do not get pulled by the overlay material 23 into the transitioning fingers 56 to become damaged.

Another advantage of the present invention is that the cutting equipment does not get damaged as a result of cut parts 16 being caught in the transitioning fingers 56.

In the preferred embodiment, the first and second flanges 82, 84 of the overlay pinch mechanisms 70, 72 are fabricated from metal, whereas the arm 86 and the toggle clamp body 104 are fabricated from plastic. The wheel 80 is manufactured from rubber. However, other materials can be used to manufacture parts of the overlay pinch mechanisms 70, 72. Although the embodiment described herein shows that the first and second flanges 82, 84 are attached together by means of fasteners, the flanges 70, 72 can be manufactured as a single integral piece. Similarly, the arm 86 also can be either secured to the second flange 84 by means of fasteners or be integrally formed therewith.

While the present invention has been illustrated and described with respect to a particular embodiment thereof, it should be appreciated by those of ordinary skill in the art, that various modifications to this invention may be made without departing from the spirit and scope of the present invention. For example, the overlay pinch mechanisms 70, 72 can be also attached to the cutter table 20.

We claim:

1. An overlay pinch mechanism comprising:
a bracket for mounting said mechanism onto a cutter system table; and
a clamp pivotally attached onto said bracket, said clamp having an engaged position and a disengaged position, in said engaged position said clamp engaging an overlay material covering a lay to prevent said overlay material from being displaced.

2. The overlay pinch mechanism according to claim 1 further comprising:
a wheel mounted onto said clamp and being rotatable about a wheel shaft, said wheel engaging said overlay material and applying pressure thereto to hold said overlay material against a conveyor surface of said table.

3. The overlay pinch mechanism according to claim 2 further comprising:
a pin mounted within said bracket in a substantially parallel relationship to said wheel shaft; and
a pair of springs engaging said wheel shaft and said pin to maintain said wheel supported by said clamp in contact with said table.

4. The overlay pinch mechanism according to claim 2 wherein said wheel is textured to mate with said conveyor surface of said table.

5. The overlay pinch mechanism according to claim 1 wherein said clamp is spring loaded.

6. The overlay pinch mechanism according to claim 1 further comprising:
means for tensioning said clamp to maintain said clamp pressed against a conveyor surface of said table in said engaged position and resting against said bracket in said disengaged position.

7. The overlay pinch mechanism according to claim 6 wherein said means is a pair of springs.

8. The overlay pinch mechanism according to claim 1 wherein said bracket includes:
a first flange attaching onto a side of said table;
a second flange attached to said first flange by means of fasteners in a substantially perpendicular relationship thereto; and
an arm fixedly attached to said second flange and pivotally supporting said clamp.

9. The cutter system according to claim 1 wherein said clamp further comprises a handle for toggling said clamp between said engaged position and said disengaged position.

10. A cutter system for cutting a single ply or multiple plies of limp material defining a lay into parts, said lay being covered by an overlay material, said cutter system comprising:
a cutter table for supporting said lay, said cutter table having a take-on end and a take-off end;
a cutter head supporting a tool assembly, said cutter head being disposed over said cutter table and movable with respect thereto for cutting said lay into a plurality of parts;
a takeoff table placed substantially adjacent to said take-off end of said cutter table; and
an overlay pinch apparatus secured to said take-off table and placing said overlay material in tension to prevent displacement of said overlay material during transitioning of said lay from said cutter table onto said take-off table.

11. The cutter system according to claim 10 wherein said overlay pinch apparatus includes a first overlay pinch mechanism attached to one side of said take-off table and a second overlay pinch mechanism attached to an opposite side of said take-off table.

12. The cutter system according to claim 11 wherein each said overlay pinch mechanism comprises:
a bracket for mounting said mechanism onto said take-off table; and
a clamp pivotally attached onto said bracket, said clamp having an engaged position and a disengaged position, in said engaged position said clamp engaging said overlay material covering said lay to prevent said overlay material from being displaced.

13. The overlay pinch mechanism according to claim 12 further comprising:
a wheel mounted onto said clamp and being rotatable about a wheel shaft, said wheel engaging said overlay material and applying pressure thereto to hold said overlay material against a conveyor surface of said take-off table.

14. The overlay pinch mechanism according to claim 13 further comprising:
a pin mounted within said bracket in a substantially parallel relationship to said wheel shaft; and
a pair of springs engaging said wheel shaft and said pin to maintain said wheel supported by said clamp in contact with said table.

15. The overlay pinch mechanism according to claim 10 wherein said clamp is spring loaded.

16. The overlay pinch mechanism according to claim 10 further comprising:
means for tensioning said clamp to maintain said clamp pressed against a conveyor surface of said table in said engaged position and resting against said bracket in said disengaged position.

17. The overlay pinch mechanism according to claim 16 wherein said means is a pair of springs.

18. The overlay pinch mechanism according to claim 10 wherein said bracket includes:
a first flange attaching onto a side of said table;
a second flange attached to said first flange by means of fasteners in a substantially perpendicular relationship thereto; and
an arm fixedly attached to said second flange and pivotally supporting said clamp.

19. An overlay pinch apparatus for use in cutter systems comprising:
a first overlay pinch mechanism attached to one side of a cutter system table for applying pressure to one side of overlay material to prevent said overlay material from being displaced; and
a second overlay pinch mechanism attached to an opposite side of said cutter system table for applying pressure to another side of said overlay material to prevent said overlay material from being displaced.

20. The overlay pinch apparatus according to claim 19 wherein each said overlay pinch mechanism comprises:
a bracket for mounting said mechanism onto said cutter system table; and
a clamp pivotally attached onto said bracket, said clamp engaging said overlay material covering said lay.

21. A method for cutting a lay of limp material on a cutter table and conveying said lay from said cutter table onto a take-off table, said method comprising the steps of:
placing said lay on a support surface of said cutter table;
placing a layer of overlay material atop of said lay and extending a free end of said overlay material over to said take-off table;
engaging said free end of said overlay material with at least two overlay pinch mechanisms;
cutting said lay into a plurality of parts;
conveying said lay from said cutter table onto said take-off table; and
maintaining said overlay material in tension and preventing said overlay material from being displaced during the conveying.
